(19) United States
(12) Patent Application Publication
(10) Pub. No.: US 2002/0180658 A1
(43) Pub. Date: Dec. 5, 2002

(54) Information display unit for vehicle and advertisement system and advertisement method using the information display unit

(75) Inventors: Keishi Saito, Saitama (JP); Tetsu Yamagori, Saitama (JP)

Correspondence Address: SUGHRUE MION, PLLC, 2100 PENNSYLVANIA AVENUE, N.W., WASHINGTON, DC, 20037, US

(73) Assignee: PIONEER CORPORATION

(21) Appl. No.: 10/155,923

(22) Filed: May 28, 2002

(30) Foreign Application Priority Data
May 30, 2001 (JP) P. 2001-162712

(51) Int. Cl. G09G 5/00; G09G 3/30

(52) U.S. Cl. 345/1.3

(57) ABSTRACT

An information display unit is used for a vehicle for displaying information inside and outside the vehicle. The information display unit includes a display portion having flexibility, and a drive electrode disposed on one side of the display portion. Information displayed on the information display unit is electrically changed in response to change of at least one of a current position and a current time of the vehicle.

### BACKGROUND OF THE INVENTION

1. Field of the Invention

This invention relates to an advertisement display of a vehicle such as an electric train, a bus, or a taxi and in particular to an information display unit for a vehicle that can change the contents of the display in response to the position of the vehicle and the time, and an advertisement system and an advertisement method using the information display unit.

2. Description of the Related Art

Hitherto, as advertisement media, posters put on a passage and a wall of a stop station of a transit system, in an electric train, etc., POP advertisements put inside and outside various sales stores, and dangling advertisements in trains have been available; they are put at locations attracting publicity. The advertisements are replaced with other advertisements after the expiration of a given time interval. At the locations attracting publicity, the advertisement effect is also high and therefore the advertisements are replaced after the expiration of an extremely short time interval. Particularly, the advertisements in electric trains produce the highest advertisement effect and may be replaced daily or may be replaced morning and evening in some cases.

Advertisements are replaced by hands; the advertisements in electric trains need to be replaced frequently as described above and it is necessary to replace a large amount of advertisements put in all vehicles in an extremely short time and therefore much labor is required for the replacement work. Particularly, to replace the advertisements in the morning and evening, they are replaced during the train service and thus only the dangling advertisements are replaced because of comparatively easily replacement work; the advertisements put on walls cannot frequently be replaced because of cumbersome replacement work under present circumstances. Since the advertisement media are printed matter, to replace the advertisements, a large amount of printed matter needs to be provided and further the replaced advertisements are not reused and become a large amount of waste.

Further, the types of information required for the passengers using vehicles such as electric trains differ between the morning or evening commuting time period and the daytime time period and also vary from one use region to another. However, with the current print media using the printed matter, the advertisement contents cannot frequently be changed and thus cannot efficiently appeal to the customers; this is also a problem.

On the other hand, in recent years, advertisement information has been displayed on a small-sized monitor installed on the wall of an electric train, so that the advertisement contents are easily changed simply by updating the data of the advertisement information. However, a liquid crystal display usually used as the monitor has a structure of sandwiching a liquid crystal layer between glass substrates and thus the display itself is solid and if an attempt is made to provide a reasonable display area, the display itself becomes heavy. Therefore, to install the monitor in a moving electric train, it is installed only on the wall, etc., where the monitor can be reliably fixed, and the monitor cannot be dangled from the ceiling although a dangling advertisement can produce the highest advertisement effect.

### SUMMARY OF THE INVENTION

It is therefore an object of the invention to provide an information display unit for a vehicle, which enables easy change of the contents of advertisement information, etc., placed in a vehicle such as an electric train or a bus and can be attached to any location where an existing printed matter advertisement is placed, and an advertisement system and an advertisement method using the information display unit.

According to the invention, there is provided an information display unit for a vehicle (information display unit 101-106) for displaying information inside and outside the vehicle (electric train, etc.,), characterized in that the information display unit is provided with flexibility and drive electrodes (electrodes 110) of the information display unit are concentrated on one side for attaching the information display unit to both or either of the inside and the outside of the vehicle and information displayed on the information display unit is electrically changed in response to change in vehicle information of both or either of the position and the current time of the vehicle.

According to the invention, to display advertisement information by electrically changing the display contents of the information display unit in response to change in the position and the current time of the moving vehicle, the replacement work formerly performed by hands to change the advertisement contents becomes unnecessary and the display contents can be changed easily. The electrodes of the information display unit are concentrated on one side, whereby the information display unit can be provided with flexibility and to attach the information display unit to a wall, etc., having a curved surface, the information display unit can also be attached to a similar position to that of the current printed matter advertisement along the wall.

The information display unit is an organic EL (electroluminescence) display. The organic EL display is used as the display unit, so that flexibility of the display unit can be provided easily.

The information display unit is used as a dangling advertisement with one side of the information display unit fixed to a ceiling of the vehicle as the top margin of the information display unit. According to the invention, the information display unit is attached to the ceiling of a vehicle with the one side where the electrodes are concentrated as a support part, so that it can be used as a dangling advertisement like printed matter.

The information is displayed on double sides of the information display unit. According to the invention, the information is displayed on double sides of the information display unit, so that the double sides of the unit can be utilized effectively and the information display unit can be applied to the display mode requiring double-sided display like dangling advertisements.

According to the invention, there is provided an advertisement system for displaying advertisement information inside and outside a vehicle (electric train, etc.,), the advertisement system comprising at least one information display unit (information display unit 301) for displaying the advertisement information, a storager (memory 304) for storing advertisement data to be displayed on the information display unit, a vehicle information determination unit (GPS) for determining vehicle information of both or either of the current position and the current time of the vehicle, and a controller (control section 302) for supplying the advertisement data stored in the storager to the information display unit in response to change in the vehicle information, thereby changing the advertisement information.

According to the invention, the advertisement system replacing the current printed matter advertisement can be provided by using the information display unit that can change the display contents in response to change in the vehicle information of the current position and the current time of the vehicle and can be put as a dangling advertisement like a printed matter advertisement and can be attached to a wall, etc., having a curved surface like printed matter.

The advertisement system comprises the information display unit, the storager, and the controller for each vehicle and further comprises a data acquisition unit being placed in at least one vehicle for acquiring new advertisement data to update the advertisement data stored in the storager.

According to the invention, the advertisement system comprises the information display unit, the storager, and the controller for each vehicle, whereby if the number of vehicles of a train, etc., including a plurality of vehicles is changed, the advertisement system can be constructed simply by joining or separating the vehicles without changing the system configuration of each vehicle.

The data acquisition unit plays back a storage medium or reproduces advertisement data stored on a storage medium in the moving vehicle, thereby acquiring new advertisement data. According to the invention, data acquisition for updating can be completed in the vehicle, so that a transmission line for data transmission need not be provided.

The data acquisition unit downloads advertisement data from the outside of the moving vehicle, thereby acquiring new advertisement data. According to the invention, to acquire the data for updating, the data is downloaded from the outside of the vehicle, so that a large-scaled server, etc., outside the vehicle can be accessed for acquiring the most recent data; the advertisement system is useful particularly when the vehicle moves in a wide range and a large number of advertisements are required.

The data acquisition unit receives advertisement data distributed as an information terminal is operated, thereby acquiring new advertisement data. According to the invention, the necessary data can be distributed whenever necessary by operating the information terminal, so that the advertisment contents can be changed whenever necessary without providing any advertisement to be displayed.

The vehicle information determination unit determines the current position using a positioning system, thereby acquiring the vehicle information. According to the invention, using a positioning system such as the GPS which comes into widespread use as a position determination system, the position of the moving vehicle can be easily determined simply by receiving radio waves from a satellite. The system can be applied to every moving vehicle of an electric train, a bus, a taxi, etc.

The moving vehicle runs on a predetermined track in accordance with a predetermined timetable and the vehicle information determination unit acquires the vehicle information based on the timetable. According to the invention, when an electric train, a bus on a regular route, etc., runs on a predetermined track in accordance with a predetermined timetable, the vehicle information is acquired using the timetable, whereby it can be acquired more easily as compared with the case where the GPS is newly introduced.

According to the invention, there is provided an advertisement method for displaying advertisement information on an information display unit being placed in a vehicle (electric train, etc.,), the advertisement method comprising the steps of acquiring the current position of the vehicle (S401), determining whether or not the vehicle is positioned in a region corresponding to the advertisement contents displayed at present (S403), and if the vehicle is positioned outside the region, newly acquiring advertisement data corresponding to the region in which the vehicle is positioned (S404) and changing the advertisement displayed on the information display unit based on the acquired advertisement data (S405).

The advertisement method further comprises the steps of determining the current time of day (S402), determining whether or not the current time of day is a previously specified time of day as the time of day at which the advertisement is to be updated (S406), if the time of day is the previously specified time of day, acquiring new advertisement data to be displayed at the specified time of day (S404), and if the time of day is the previously specified time of day, acquiring new advertisement data to be displayed at the specified time of day and changing the advertisement displayed on the information display unit based on the acquired advertisement data (S405). According to the invention, the advertisement method replacing the current printed matter advertisement can be provided by using the display unit that can change the display contents in response to change in the vehicle information of the current position and the current time of the vehicle and can be put as a dangling advertisement like a printed matter advertisement and can be attached to a wall, etc., having a curved surface like printed matter.

### BRIEF DESCRIPTION OF THE DRAWINGS

FIG. 1 is a drawing to show information display units installed in an electric train according to the invention.

FIG. 2 is a drawing to show a schematic structure of the information display unit shown in FIG. 1.

FIG. 3 is a drawing to show an advertisement system according to the invention.

FIG. 4 is a flowchart to show an advertisment method to change the advertisement contents according to the invention.

### SUMMARY OF THE INVENTION

Referring now to the accompanying drawings, there is shown a preferred embodiment of the invention.

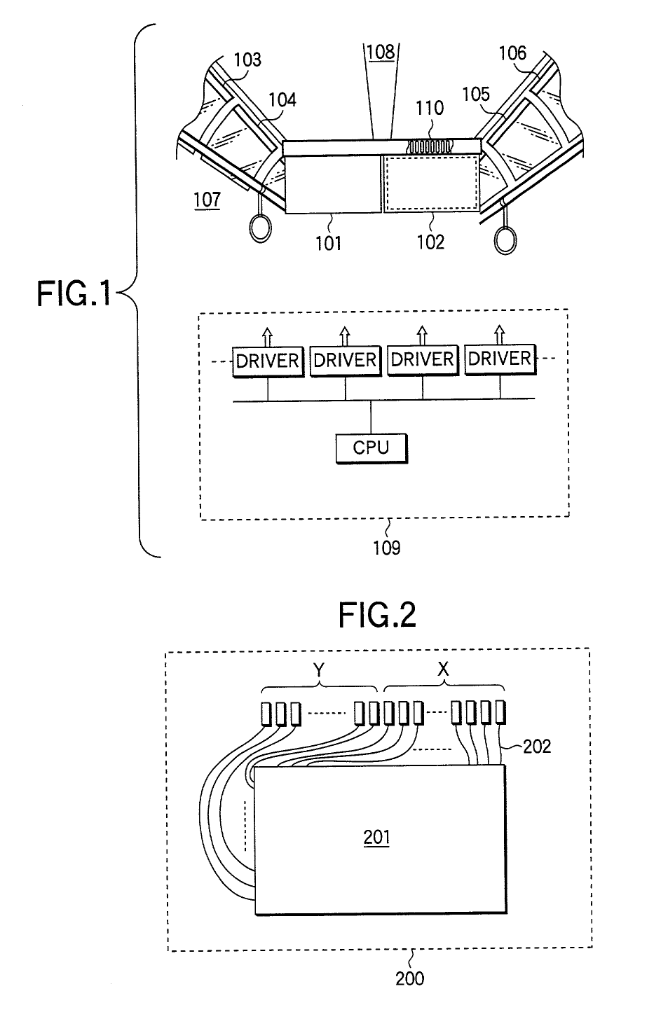

FIG. 1 shows one embodiment of the invention. In an electric train of a vehicle, information displays 101 to 106 according to the invention are attached to walls 107 and dangled from a ceiling 108. The information display units 101 to 106 are driven separately by a control section 109 and can display different contents of information.

The information display unit is implemented as a sheet-like organic EL (electroluminescence) display having flexibility, which will be hereinafter referred to as display whenever necessary. The information display unit includes an EL light emission section 201 including EL elements placed on a flexible substrate and electrodes 110 connected to the EL elements. The display face is covered with a transparent material such as a film and the whole is sealed with a flexible material, whereby the whole display is provided with flexibility. The display is driven by a known drive method. Particularly, if high-speed response is required as in moving image display, etc., the display is driven by a TFT (thin-film transistor) method.

FIG. 2 shows the structure of display 200. The electrodes connected to the EL light emission section 201 comprise data electrodes X and scan electrodes Y to drive the EL light emission section 201 as a matrix, and all the electrodes are concentrated on one side. The EL elements are connected by wiring 202 drawn out from the electrodes. The side on which the electrodes are aligned in a row is the top margin and the display can be fixed onto the ceiling or wall of an electric train with the top margin as a support portion. On the other hand, since the display has flexibility, any other portion than the support portion where the electrodes are concentrated moves flexibly and the display can behave like printed matter.

The display is used as a display unit for displaying an advertisement, whereby to attach the display to a wall having a curved surface. The display can also be put along the wall and if the space of the wall, etc., is sufficient, the electrodes may be in any other portion than the top margin. To attach the display to the ceiling, it can also be dangled from the ceiling in a one-side support state. Therefore, the display can replace the current printed matter and can be attached anywhere as desired in a sense like printed matter.

To dangle the display unit from the ceiling for use as a dangling advertisement, one display unit can also display an advertisement on double sides. In this case, two displays are placed in one piece for displaying an advertisement on each display or light of the light emission section of one display is transmitted alternately from the cathode side and the anode side, whereby double-sided display is made possible. In either case, a drive signal for each advertisement display is supplied in a time division multiplexing manner, whereby display control of the double sides of the display unit is made possible.

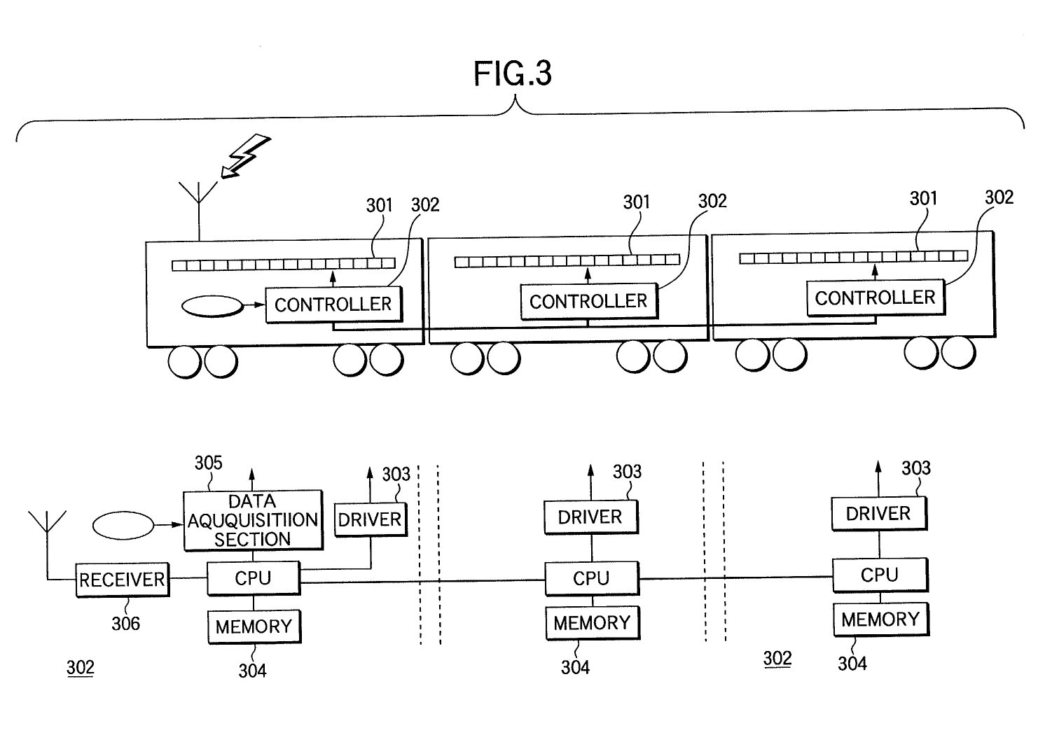

An advertisement system according to the invention will be discussed. FIG. 3 is a drawing to show the configuration of the system and shows applying the advertisement system to a train comprising a plurality of vehicles joined. A plurality of information display units 301 according to the invention are installed on walls, etc., of each of the plurality of joined vehicles like former printed matter advertisements. The information display units 301 attached to each vehicle are controlled separately by a control section 302 provided for each vehicle. The control sections 302 operate in association with each other by bus connection under the control of the control section (main CPU) installed in the top vehicle, etc., and display the same contents on the information display units 301 in the vehicles and can also display different contents separately for each vehicle. The control section (main CPU) installs a program to control the whole display in each vehicle in response to the vehicle position and the time and starts the program in association with the move of the vehicle and the passage of time for changing the display contents.

Each control section comprises a driver 303 for driving the information display units and memory 304 for retaining advertisement data for display. The memory 304 for retaining advertisement data previously retains a plurality of pieces of advertisement data and retains image data read from an external record medium such as a CD-ROM or a DVD by a data acquisition section 305 and image data stored in a server, etc., installed outside the vehicle and image data transmitted from a portable terminal and downloaded through the receiver 306 for read.

To acquire advertisement data, the data stored in a server, etc., outside the vehicle may be downloaded; the data stored in DVD, HDD, semiconductor memory, etc., may be read under the control of the control section (main CPU) installed in the top vehicle and be transferred to the memory in each vehicle for storage. The main CPU adds and transfers the position data specifying which position of the display units each advertisement is to be displayed at as header information in addition to the advertisement data. Communications with the outsides of the vehicles and those between the vehicles may be conducted not only in a wireless connection manner using the receiver 306, but also in a wired connection manner using the train railroad track. The vehicle installs a GSP receiver for determining the current position of the running vehicle and vehicle information at the current time using the GPS described later.

A flow of advertisement data will be discussed by taking display of an advertisement of the same contents in the vehicles as an example. To begin with, before service of vehicles from a depot is started, advertisement data is acquired and is stored in the memory 304 provided in each vehicle (initialization). After the service is started, as the running vehicles move in a plurality of regions in order, the advertisement data stored in the memory 304 is updated in order each time the vehicles enter each region.

The control CPU installed in each vehicle displays the updated advertisement data on the specified display unit for changing the advertisement. The advertisement data is provided corresponding to each region. To download the advertisement data by wireless communication, in a radio base station in each region, the advertisement data corresponding to the region is provided. Since it takes time in downloading the advertisement data containing image data, only index information indicating the data contents (address, program name, etc.,) may be downloaded and data stored on the record medium installed in the vehicle may be accessed based on the index information for reproducing and displaying the advertisement data.

If the advertisement system is constructed uniquely by the enterprise of railroad, bus, taxi, etc., the charge system may be determined between a client and the enterprise. To construct the advertisement system by a plurality of enterprises and an advertisement agent leading the enterprises, a client pays a charge and each enterprise introducing the advertisement system collects the advertisement publishing charge from the advertisement agent in response to the actual result of the advertisement.

An advertisement method in the advertisement system will be discussed. The types of information required for the passengers using vehicles such as electric trains differ between the morning or evening commuting time period and the daytime time period and also vary from one use region to another. Thus, the contents of the advertisement displayed on each display unit are changed in response to the position of the running vehicle and the service time. For example, a display sequence is preset so that various pieces of information on stores, service, etc., relevant to the region can be displayed in order in the time period specified by the client; in addition, using terminals of mobile telephones, etc., an advertisement of the necessary contents is displayed whenever necessary.

Taking the Keihin Tohoku line in Japan as an example, an advertisement of the contents fitted for each region is displayed whenever the service area changes in such a manner that in the service area for Yokohama from Oofuna, an advertisement concerning the department stores in the neighborhood of Yokohama is displayed on the display units in the train, that in the service area for Tokyo from Yokohama, the advertisement is changed to an advertisement concerning an arcade of well-known stores in Marunouchi in Tokyo or home electrical products volume sellers in Akihabara in Tokyo when Yokohama is passed, and that in the service area for Oomiya, the advertisement is changed to an advertisement concerning Sonic City in Oomiya when Tokyo is passed. As a display method considering the service time, an advertisement of the contents fitted for the time period is displayed in such a manner that an advertisement concerning the bargain sale of an electric appliance store is displayed in the daytime and that an advertisement concerning restaurants is displayed in the evening. The display contents may be changed arbitrarily as a spot advertisement.

To change the advertisement contents in response to the service area, the current position at which the running vehicle exists is determined. The current position can be determined using the GPS, for example. In this case, a GPS receiver for receiving radio waves from a satellite is installed in the vehicle. The GPS can be used to determine the position of every moving vehicle of an electric train, a bus, a taxi, etc. On the other hand, an electric train, a bus on a regular route, etc., moves on a predetermined track in accordance with a predetermined timetable and thus the current position of the running vehicle can also be determined from the current time of day based on the timetable.

On the other hand, the running position and the service time of a vehicle such as a taxi are not fixed and thus the current position is determined using the GPS and an advertisement of the contents fitted for the region is displayed in the actual time period during which a person gets in the vehicle.

Of vehicle information, the current time of day can be acquired together with the current position information when the GPS is used; it can also be acquired by acquiring the time data from the clock installed in the vehicle.

The advertisement display may be intended not only for the passengers, but also for pedestrians, drivers, etc., with the display unit placed on the outside of the vehicle.

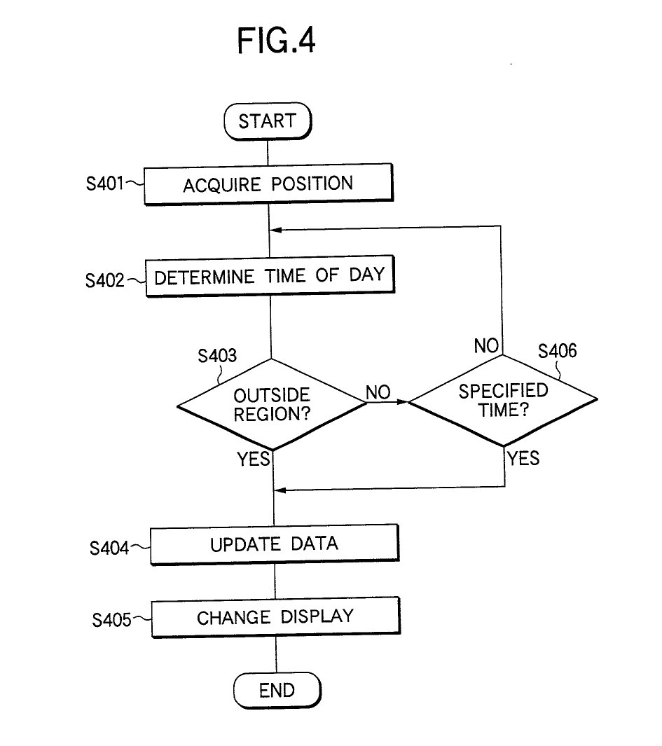

FIG. 4 shows an advertisement method to change the advertisement contents. To begin with, the current position of the vehicle is acquired using the GPS, etc., (S401) and the current time of day is determined (S402). Next, whether or not the vehicle is positioned in the region corresponding to the advertisement contents displayed at present is determined (S403). If the vehicle is positioned outside the region, the advertisement data corresponding to the region in which the vehicle is positioned is downloaded and the advertisement data is updated (S404) and a new advertisement is displayed (S405). On the other hand, if the vehicle is positioned inside the region, further whether or not the time of day is the previously specified time of day as the time of day at which the advertisement contents are to be updated is determined (S406). If the time of day is the specified time of day, new advertisement data to be displayed at the specified time of day is acquired (S404) and a new advertisement is displayed (S405).

In the embodiment, displaying of advertisement information has been described. However, in addition, display information, such as service information or weather information, may be updated in real time in response to the region and the time changing as the vehicle moves, and may be displayed together with the advertisement information. As the display mode, a still image or a moving image may be displayed or a still image and a moving image may be displayed in combination. Further, to acquire the data of advertisement information, in addition to acquiring the data from a record medium, etc., of a vehicle, etc., and the index information from an external base station, etc., as described above, image information and text data may be acquired. For example, as for data having a large information amount such as image information, information of advertisement data, etc., can also be previously read from the outside at a predetermined position outside the region.

What is claimed is:

1. An information display unit for a vehicle for displaying information inside and outside the vehicle, the information display unit comprising:
a display portion having flexibility; and
a drive electrode disposed on one side of the display portion,
wherein information displayed on the information display unit is electrically changed in response to change of at least one of a current position and a current time of the vehicle.

2. The information display unit as claimed in claim 1, wherein the display portion is an organic EL display.

3. The information display unit as claimed in claim 1, wherein the one side of the display portion is fixed to a ceiling of the vehicle to be used as a dangling advertisement.

4. The information display unit as claimed in claim 3, wherein the information is displayed on both sides of the display portion.

5. An advertisement system for displaying advertisement information inside and outside a vehicle, the advertisement system comprising:
an information display unit which displays the advertisement information, the information display unit comprising:
a display portion having flexibility; and
a drive electrode disposed on one side of the display portion,
wherein the advertisement information displayed on the information display unit is electrically changed in response to change of at least one of a current position and a current time of the vehicle;
a storager which stores the advertisement information to be displayed on the display portion;
a vehicle information determination unit which determines the at least one of the current position and the current time of the vehicle; and
a controller which supplies the advertisement information stored in the storager to the information display unit to change the advertisement information in the display portion in response to change of the at least one of the current position and the current time of the vehicle.

6. The advertisement system as claimed in claim 5, further comprising a data acquisition unit disposed in the vehicle, the data acquisition unit acquires an updated advertisement information to update the advertisement information stored in the storager.

7. The advertisement system as claimed in claim 6 wherein the data acquisition unit plays back a storage medium or reproduces data stored on the storage medium to acquire the updated advertisement information.

8. The advertisement system as claimed in claim 6 wherein the data acquisition unit downloads data from an outside of the vehicle to acquire the updated advertisement information.

9. The advertisement system as claimed in claim 6 further comprising an information terminal for controls the data acquisition unit to receive data and to acquire the updated advertisement information.

10. The advertisement system as claimed in claim 5, wherein the vehicle information determination unit determines the current position using a positioning system.

11. The advertisement system, as claimed in claim 5, wherein the vehicle runs on a predetermined track in accordance with a predetermined timetable; and
the vehicle information determination unit acquires the at least one of the current position and the current time of the vehicle based on the timetable.

12. An advertisement system for displaying advertisement information inside and outside a vehicle including a plurality of sub-vehicles, the advertisement system comprising:
an information display unit, the information display unit which displays the advertisement information, the information display unit comprising:
a display portion having flexibility; and
a drive electrode disposed on one side of the display portion,
wherein the advertisement information displayed on the information display unit is electrically changed in response to change of at least one of a current position and a current time of the vehicle;
a storager which stores the advertisement information to be displayed on the display portion;
a vehicle information determination unit which determines the at least one of the current position and the current time of the vehicle; and
a controller which supplies the advertisement information stored in the storager to the information display unit to change the advertisement information in the display portion in response to change of the at least one of the current position and the current time of the vehicle,
wherein the information display unit, the storage and the controller are provided for each of the sub-vehicle.

13. The advertisement system as claimed in claim 12, further comprising a data acquisition unit disposed in at least one of the sub-vehicles, the data acquisition unit acquires an updated advertisement information to update the advertisement information stored in the storager.

14. The advertisement system as claimed in claim 13, wherein the data acquisition unit plays back a storage medium or reproduces data stored on the storage medium to acquire the updated advertisement information.

15. The advertisement system as claimed in claim 13, wherein the data acquisition unit downloads the advertisement information from an outside of the vehicle to acquire the updated advertisement information.

16. The advertisement system as claimed in claim 13, further comprising an information terminal for controls the data acquisition unit to receive data and to acquire the updated advertisement information.

17. The advertisement system as claimed in claim 12, wherein the vehicle information determination unit determines the current position using a positioning system.

18. The advertisement system as claimed in claim 12, wherein the vehicle runs on a predetermined track in accordance with a predetermined timetable and the vehicle information determination unit acquires the at least one of the current position and the current time of the vehicle based on the timetable.

19. An advertisement method for displaying advertisement information on an information display unit being placed in a vehicle, the advertisement method comprising:
acquiring a current position of the vehicle;
determining the current position to be outside a region corresponding to contents of the advertisement information displayed at present; and
acquiring an updated advertisement information corresponding to the current position; and
changing the advertisement information displayed on the information display unit based on the updated advertisement information.

20. The advertisement method as claimed in claim 19 further comprising:
determining a current time of day;
determining the current time of day to be a specified time of day in advance;
acquiring an updated advertisement information to be displayed at the specified time of day; and
changing the advertisement information displayed on the information display unit based on the updated advertisement information.
